(19) United States
(12) Patent Application Publication
(10) Pub. No.: US 2014/0180698 A1
(43) Pub. Date: Jun. 26, 2014

(54) INFORMATION PROCESSING APPARATUS, INFORMATION PROCESSING METHOD AND STORAGE MEDIUM

(71) Applicant: KABUSHIKI KAISHA TOSHIBA, Tokyo (JP)

(72) Inventor: Lim Zhi Kai, Hachioji-shi (JP)

(73) Assignee: KABUSHIKI KAISHA TOSHIBA, Tokyo (JP)

(21) Appl. No.: 14/017,657

(22) Filed: Sep. 4, 2013

Related U.S. Application Data
(63) Continuation of application No. PCT/JP2013/058115, filed on Mar. 21, 2013.

(30) Foreign Application Priority Data
Dec. 26, 2012 (JP) 2012-283546

(51) Int. Cl. G10L 21/06

(52) U.S. Cl. CPC G10L 21/06
USPC 704/275

(57) ABSTRACT

According to one embodiment, an information processing apparatus includes a display, a touch panel on the display, and a voice recognition module. The display is configured to display video. The touch panel is configured to detect a touch. The voice recognition module is configured to perform voice recognition processing based on a position of the touch detected by the touch panel.

### CROSS-REFERENCE TO RELATED APPLICATIONS

This application is a Continuation Application of PCT Application No. PCT/JP2013/058115, filed Mar. 21, 2013 and based upon and claiming the benefit of priority from Japanese Patent Application No. 2012-283546, filed Dec. 26, 2012, the entire contents of all of which are incorporated herein by reference.

### FIELD

Embodiments described herein relate generally to an information processing apparatus including a touch panel, an information processing method, and a program.

### BACKGROUND

In recent years, various information processing apparatuses such as tablets, PDAs, and smartphones have been developed. Most of such kinds of electronic devices include a touch screen display to facilitate an input operation by the user. The user can give instructions to the information processing apparatus to execute a function related to a menu or object by touching the menu or object displayed on the touch screen display with a fingertip, stylus pen or the like.

However, many of existing information processing apparatuses including a touch panel are small and thus, it is difficult to use copy & paste and cut & paste needed for text editing. In these operations, it is necessary to specify the start position or end position of copy or cut and the paste position using a fingertip, stylus pen or the like and in some cases, it is difficult to precisely specify these positions. That is, if the screen is small and characters are small, it is difficult to precisely specify a character or a word using a fingertip, stylus pen or the like.

When using an information processing apparatus including a conventional touch panel, it is difficult to precisely select a portion of text including small characters using the touch panel.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an appearance of an information processing apparatus according to an embodiment.

FIG. 2 is a block diagram showing an example of a system configuration of the information processing apparatus according to the embodiment.

FIG. 3 is a block diagram showing an example of a function configuration of a text editing application according to the embodiment.

FIG. 4 is a flow chart showing the flow of processing of the text editing application according to the embodiment.

FIG. 5 is a diagram showing an example of text to be edited.

FIGS. 6A, 6B, and 6C are diagrams showing copy or cut start position candidates/end position candidates and past position candidates when the text in FIG. 5 is edited.

FIG. 7 is a diagram showing another example of text to be edited.

FIGS. 8A, 8B, and 8C are diagrams showing copy or cut start position candidates/end position candidates and past position candidates when the text in FIG. 7 is edited.

FIG. 9 is a diagram showing an example of phrase display in the text of FIG. 7.

### DETAILED DESCRIPTION

Various embodiments will be described hereinafter with reference to the accompanying drawings.

In general, according to one embodiment, an information processing apparatus includes a display, a touch panel on the display, and a voice recognition module. The display is configured to display video. The touch panel is configured to detect a touch. The voice recognition module is configured to perform voice recognition processing based on a position of the touch detected by the touch panel.

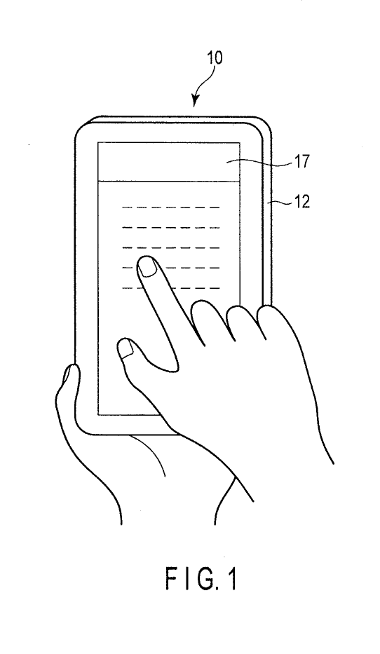

FIG. 1 is a perspective view showing an example of the appearance of an information processing apparatus according to the first embodiment. The information processing apparatus is realized, for example, as a smartphone 10 that can be carried with one hand and on which a touch operation can be performed using a fingertip, stylus pen or the like. The smartphone 10 includes a main body 12 and a touch screen display 17. The main body 12 includes a thin box-shaped cabinet. The touch screen display 17 is mounted on the front side of the main body 12 by being overlaid on an almost entire surface. A flat panel display and a sensor configured to detect the touch position (in reality, representative coordinates of a touch surface of a certain size or a region of a touch surface) of a fingertip, stylus pen or the like on the screen of the flat panel display are incorporated into the touch screen display 17. The flat panel display may be, for example, a liquid crystal display (LCD). As a sensor, for example, an electrical capacitance touch panel may be used. The touch panel is provided like covering the screen of the flat panel display. The touch panel can detect a touch operation using a fingertip, stylus pen or the like on the screen. The touch operation includes a tap operation, a double tap operation, and a drag operation and, in the present embodiment, when the touch panel is touched with a fingertip, stylus pen or the like, an operation to detect the position thereof is used.

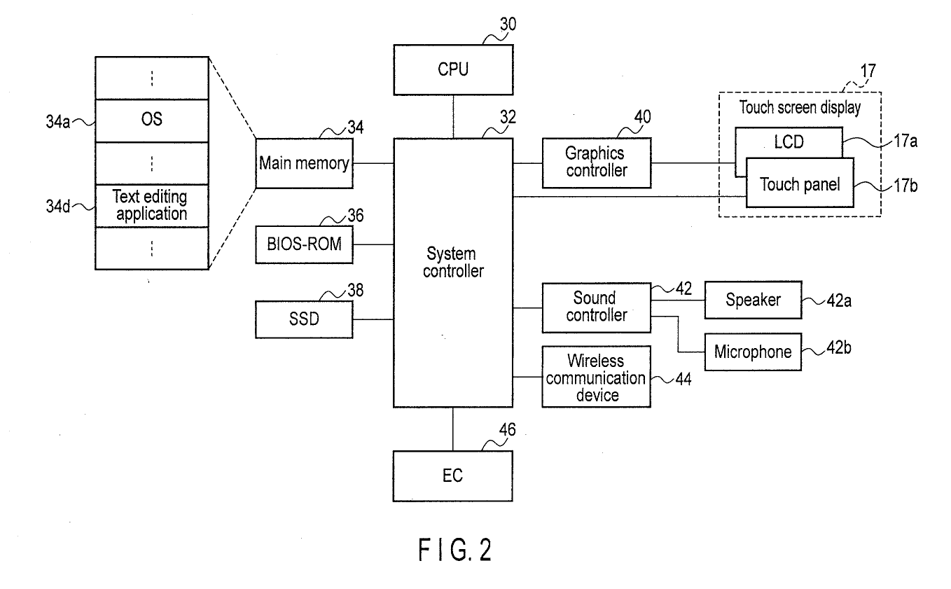

FIG. 2 shows the system configuration of the smartphone 10. The smartphone 10 includes a CPU 30, a system controller 32, a main memory 34, a BIOS-ROM 36, an SSD (Solid State Drive) 38, a graphics controller 40, a sound controller 42, a wireless communication driver 44, and an embedded controller 46.

The CPU 30 is a processor that controls the operation of various modules implemented in the smartphone 10. The CPU 30 executes various kinds of software loaded from the SSD 38 as a nonvolatile storage device into the main memory 34. The software includes an operating system (OS) 34a and a text editing application program 34d.

The text editing application program 34d controls editing (copy, cut, and paste) of text displayed on the touch screen display 17 using, in addition to the touch operation, voice recognition. More specifically, the text editing application program 34d identifies the desired word, phrase or the like from a plurality of words, phrases or the like at the touch position using voice recognition.

The CPU 30 also executes the basic input output system (BIOS) stored in the BIOS-ROM 36. BIOS is a program to control hardware.

The system controller 32 is a device connecting the CPU 30 and various components. The system controller 32 also contains a memory controller to control access. The main memory 34, the BIOS-ROM 36, the SSD 38, the graphics controller 40, the sound controller 42, the wireless communication device 44, and the embedded controller 46 are connected to the system controller 32.

The graphics controller 40 controls an LCD 17a used as a display monitor of the smartphone 10. The graphics controller 40 transmits a display signal to the LCD 17a under the control of the CPU 30. The LCD 17a displays a screen image based on the display signal. Text editing processing such as copy & paste or cut & paste is performed on text displayed on the LCD 17a under the control of the text editing application program 34d. A touch panel 17b is arranged on the display surface of the LCD 17a.

The sound controller 42 is a controller to control an audio signal and incorporates a voice input from a microphone 42b as an audio signal and also generates an audio signal output from a speaker 42a. The microphone 42b is also used for voice input of the desired word, phrase or the like to assist the touch operation.

The wireless communication device 44 is a device configured to perform wireless communication such as wireless LAN and 3G mobile communication or to perform proximity wireless communication such as NFC (Near Field Communication). The smartphone 10 is connected to the Internet via the wireless communication device 44.

The embedded controller 46 is a one-chip microcomputer containing a controller for power management. The embedded controller 46 has a function to turn on or turn off the smartphone 10 in accordance with the operation of a power button (not shown).

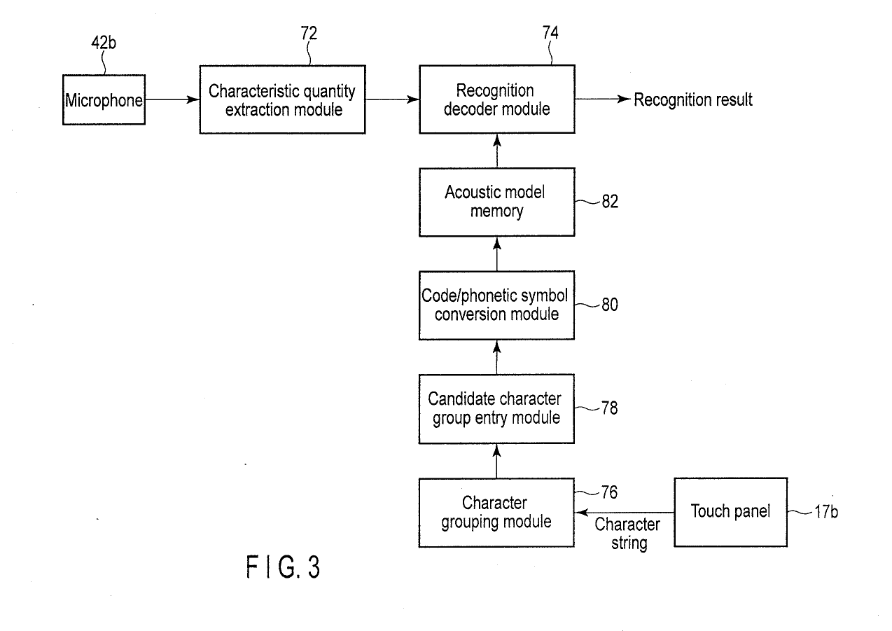

FIG. 3 is a block diagram showing the function configuration of the text editing application program 34d. In a conventional information processing apparatus including a touch panel such as a smartphone, all operations are instructed by a touch operation. In, for example, copy & paste that pastes a portion of text to the clipboard and pastes content of the clipboard to some place, the copy start position, copy end position, and paste position are specified by the touch of a fingertip, stylus pen or the like. However, one point alone cannot be touched by a fingertip, stylus pen or the like and some region is touched in reality and so it is difficult to specify only one character or one word and a plurality of characters or words is specified. To identify the desired one character or one word from the plurality of characters or words, the text editing application program 34d uses voice recognition.

An audio signal input from the microphone 42b is supplied to a characteristic quantity extraction module 72 for sound analysis. In the sound analysis, a voice is analyzed (for example, the Fourier analysis) and converted into characteristic quantities including information useful for recognition. Characteristic quantities are supplied to a recognition decoder module 74 and recognized by using acoustic models from an acoustic model memory 82. In the acoustic model memory 82, a very large number of correspondences between the sound of characteristic quantities and probabilities of phonetic symbols are stored as acoustic models.

In the present embodiment, all acoustic models stored in the acoustic model memory 82 are not used for voice recognition and, instead, only acoustic models of words in a region touched by a fingertip, stylus pen or the like on the touch panel 17b are used for voice recognition. Therefore, the precision of voice recognition is enhanced and also voice recognition can be accomplished in a short time.

Character code of a character string contained in a touch region is supplied from the touch panel 17b to a character grouping module 76 and the character string undergoes structural analysis and is classified into character groups (for example, characters, words, or phrases) including one or a plurality of characters. If only a portion of a word or phrase is contained in a touch region, the word or phrase is judged to be contained in the touch region. A plurality of character groups obtained by the character grouping module 76 is entered in a candidate character group entry module 78. A code/phonetic symbol conversion module 80 converts a character code string entered in the candidate character group entry module 78 into phonetic symbols. The acoustic model memory 82 supplies acoustic models containing phonetic symbols obtained from the code/phonetic symbol conversion module 80 to the recognition decoder module 74. That is, the recognition decoder module 74 performs voice recognition processing using acoustic models narrowed down based on character code and therefore, the precision is enhanced.

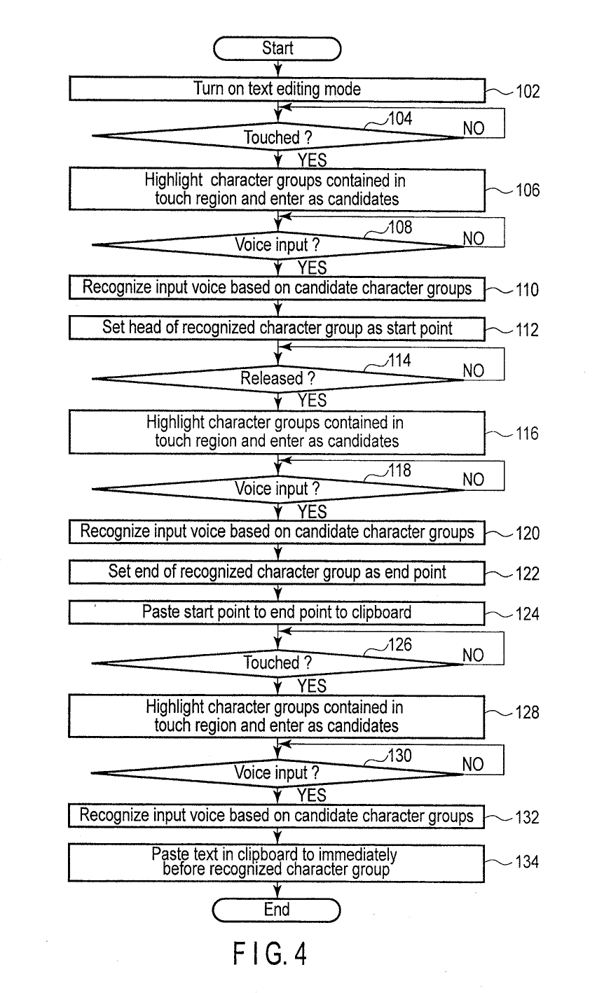

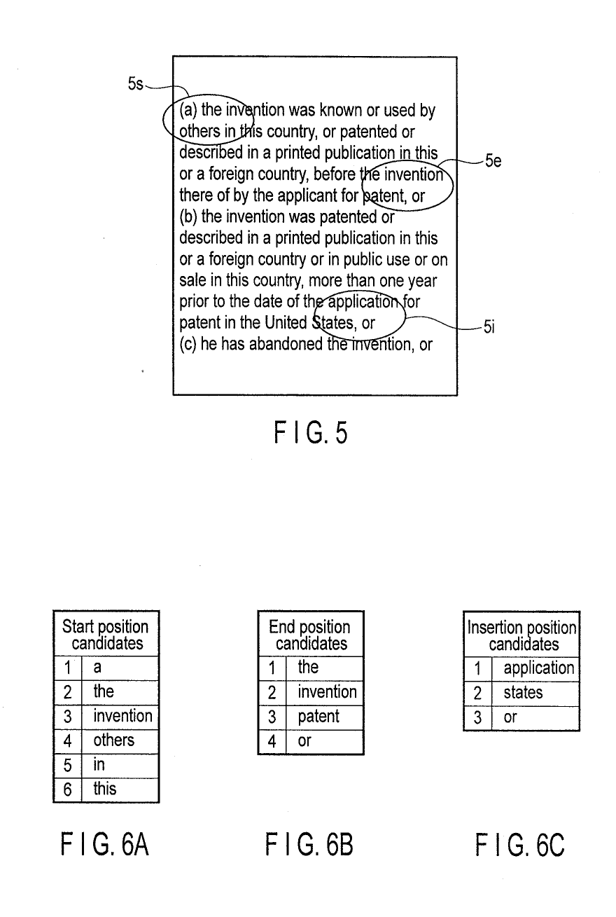

The flow of text editing processing will be described with reference to FIGS. 4, 5, and 6. FIG. 4 is a flow chart showing the flow of processing of the text editing application. FIG. 5 is a diagram showing an example of text to be edited. Here, a case when the user wants to paste text from “the” in the first line to “patent” in the fifth line to immediately before “or” in the eleventh line will be described. The paste position can also be set to immediately after some word, instead of immediately before. For example, if the user wants to paste to the end of a line, the paste position will be immediately after the word at the end of the line. Alternatively, text may be pasted to an intermediate position by identifying two words.

In block 102, the text editing mode is turned on. As an example of operation to turn on the text editing mode, the user continues to touch (long pressing) any point in a display area of text for a predetermined time or longer while the text is displayed. When the text editing mode is turned on, a text editing menu including a copy button, a cut button, and a paste button is displayed at the top of the screen. Depending on whether to copy or cut a selected portion, one of the copy button and the cut button is pressed. Here, a case when the copy button is touched and a copy & paste operation is selected will be described.

Then, as shown in FIG. 5, the user touches the word “the” at the head (copy start position) of a copy portion (YES in block 104 in FIG. 4). However, if the word is touched with a fingertip, stylus pen or the like, a region of some area is touched and a plurality of words is specified. Thus, in block 104, when a touch on the touch panel 17b is detected, all words (character groups including one or a plurality of characters) contained (even partially) in a touch region 5s are highlighted in block 106 and these words are also entered in the candidate character group entry module 78 as start character group candidates. As shown in FIG. 6A, six words of “a”, “the”, “invention”, “others”, “in”, and “this” become start position character group candidates contained in the touch region 5s.

Then, the user inputs an audio signal of “the” from the microphone 42b by pronouncing the word “the” in the place where copying should start. When the voice input is detected in block 106, the input voice is recognized in block 110 based on start character group candidates entered in block 106. That is, the word most similar to characteristic quantities of input voice from among the six candidate words of “a”, “the”, “invention”, “others”, “in”, and “this” becomes a recognition result. Because recognition objects are narrowed down as described above, input voice can be recognized correctly.

In block 112, the start position of the recognized word (“the”) is set as the copy start position.

Next, the copy end position is specified. After specifying the copy start position, the user drags the fingertip, stylus pen or the like to the word “patent” at the end (copy end position) of the copy portion while the fingertip, stylus pen or the like is in touch and then release the fingertip, stylus pen or the like (YES in block 114 in FIG. 4). When the release of the fingertip, stylus pen or the like is detected in block 114, words contained (even partially) in a touch region 5e of the fingertip or stylus pen when released are highlighted in block 116 and these words are also entered in the candidate character group entry module 78 as end character group candidates. As shown in FIG. 6B, four words of “the”, “invention”, “patent”, and “or” become end position character group candidates contained in the touch region 5e.

Then, the user inputs an audio signal of “patent” from the microphone 42b by pronouncing the word “patent” in the place where copying should end. When the voice input is detected in block 118, the input voice is recognized in block 120 based on end character group candidates entered in block 116. That is, the word most similar to characteristic quantities of input voice from among the four words of “the”, “invention”, “patent”, and “or” becomes a recognition result. Because recognition objects are narrowed down as described above, input voice can be recognized correctly.

In block 122, the end position of the recognized word (“patent”) is set as the copy end position. When the copy end position is decided, in block 124, the text from the copy start position to the copy end position is highlighted and also pasted to the clipboard.

Further, the paste position is set in the same manner. As shown in FIG. 5, the user touches the word “or” at the head of the paste position (YES in block 126 in FIG. 4). In block 128, when a touch on the touch panel 17b is detected, words contained (even partially) in a touch region 5i are highlighted in block 128 and these words are also entered in the candidate character group entry module 78 as paste position character group candidates. As shown in FIG. 6C, three words of “application”, “states”, and “or” become paste position character group candidates contained in the touch region 5i.

Then, the user inputs an audio signal of the word “or” at the head of a place to which the text should be pasted. When the voice input is detected in block 130, the input voice is recognized in block 132 based on paste position character group candidates entered in block 128. That is, the word most similar to characteristic quantities of input voice from among the three words of “application”, “states”, and “or” becomes a recognition result. Because recognition objects are narrowed down as described above, input voice can be recognized correctly.

In block 134, the content of the clipboard is pasted to immediately before the recognized word (“or”). In the case of cut & paste, the only difference is that the text portion from the start position to end position pasted to the clipboard in block 124 is deleted from the text and otherwise, both operations are the same.

According to the first embodiment, as described above, in an information processing apparatus including a touch panel, one desired word can be identified by using voice recognition from among a plurality of words specified by a touch operation. Therefore, for example, in a copy & paste or cut & paste operation that pastes a portion of text to the clipboard and pastes the content of the clipboard to some place, words in the copy start position/end position and the paste position can precisely be specified by a touch operation and voice recognition processing.

Incidentally, the voice recognition processing can selectively be turned off. The voice recognition function is hard to use in an environment where stillness is demanded like inside an office or conversely, in a noisy environment and it is desirable to turn off the function in such an environment.

Another embodiment will be described below. In the description of the other embodiment, the same reference numerals are attached to the same portions as those in the first embodiment and a detailed description thereof is omitted.

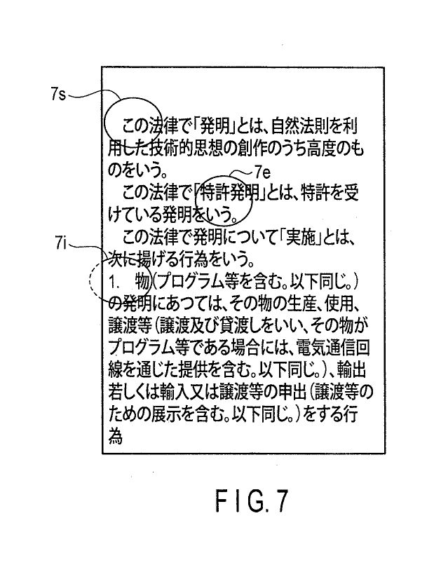

In the first embodiment, English text is edited. In the present invention, Japanese text can be similarly edited as shown in FIG. 7. The flow of processing is the same as the flow chart in FIG. 4. However, while a character string is divided into character groups in units of words in the case of English, but in the case of Japanese, text can be divided into character groups more easily and appropriately in units of phrases rather than in units of words and thus, character groups may be set as phrases. However, even in the case of Japanese, a character string may be divided into character groups in units of words. These settings can freely be changed by the user.

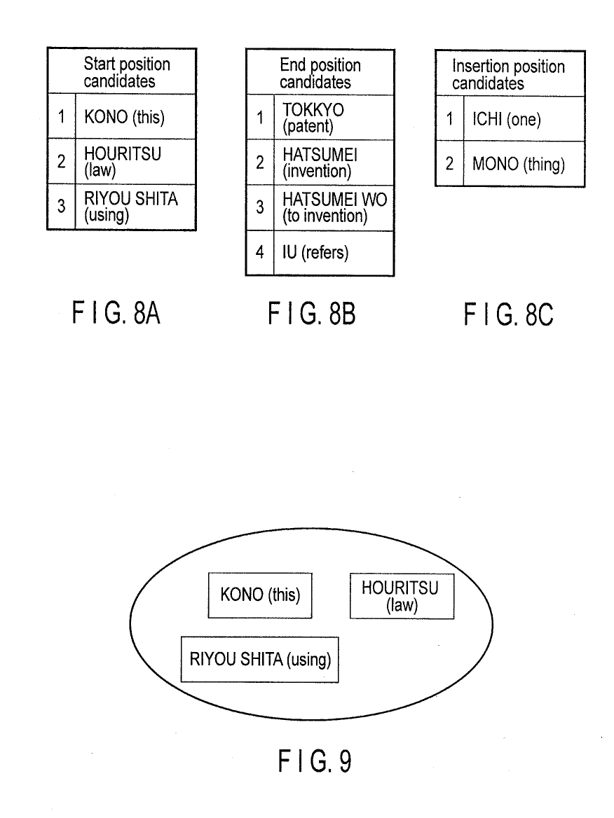

When character groups are set as phrases, as shown in FIG. 8A, three phrases of “KONO (this)”, “HOURITSU (law)”, and “RIYOU SHITA (using)” become start position character group candidates contained in the touch region 7s. The user pronounces the phrase “KONO (this)” in the position where copying should start. As shown in FIG. 8B, four phrases of “TOKKYO (patent)”, “HATSUMEI (invention)”, “HATSUMEI WO (to invention)”, and “IU (refers)” become end position character group candidates contained in the touch region 5e of a fingertip, stylus pen or the like when released. The user pronounces the phrase “IU (refers)” in the position where copying should end. As shown in FIG. 8C, two phrases of “ICHI (one)” and “MONO (thing)” become paste position character group candidates contained in the touch region 5i. The user pronounces the phrase “MONO (thing)” in the position to which the text should be pasted. Accordingly, “KONO HOURITSU (this law) to HATSUMEI WO IU (refers to invention)” can be pasted to immediately before “MONO (thing)”.

According to the second embodiment, as described above, even if text is in Japanese, the editing position of text can precisely be specified by touch & voice.

The smartphone has been described as an example of the information processing apparatus, but any information processing apparatus including a touch panel like a tablet computer, notebook personal computer, and PDA may also be used.

In the above embodiments, in order to specify the range of text to be pasted to the clipboard, the touch starts at the start position, the contact of a fingertip, stylus pen or the like continues up to the end position, and the touch is released at the end position. However, the embodiments are not limited to such an example and may have a configuration that specifies the range by touching the start position and after a fingertip, stylus pen or the like being released once, touching the end position again. That is, instead of performing voice recognition based on the start position and end position of the touch that continues for a long time, voice recognition to decide the start position/end position of the selection range based on positions of a short-time touch may be performed.

A touch operation is performed and then words or phrases contained in the touch region are highlighted before the desired word or phrase is input by voice, but the order may be reversed. That is, after the desired word or phrase is input by voice, the applicable word or phrase may be touched. Also in this case, voice recognition processing can be performed with high precision by performing voice recognition based on words or the like in the range after the range being decided by a touch. In this case, highlighting may be omitted. When the end position is specified by dragging, voice may be input before releasing.

When a character string contained in the touch range is classified into character groups including one or a plurality of characters, highlighting the whole touch range or instead, displaying a separator in order to be able to identify the classification of character groups may be more effective. That is, while words as character groups are clear when text contains only English, separation of phrases is not cleat in Japanese. In the case of FIG. 8B, for example, “TOKKYO HATSUMEI (patent invention)” may be judged to be one phrase. In this case, it is highly probable that “TOKKYO HATSUMEI (patent invention)” cannot be recognized. However, with a separator of character groups displayed or chunks of character groups displayed so as to be identifiable, character groups in the start position and end position can appropriately be input by voice. An example of the identification display of phases is shown in FIG. 9.

Because the procedure for operation control processing of an embodiment can be realized by a computer program, an effect similar to that of the embodiment can easily be realized by installing and executing the computer program through a computer readable storage medium storing the computer program on a normal compatible computer.

The present invention is not limited to the above embodiment unchanged and can be embodied by modifying elements without deviating from the spirit thereof in the stage of working. In addition, various inventions can be formed by appropriately combining a plurality of elements disclosed in the above embodiments. For example, some elements may be deleted from all elements shown in an embodiment. Further, elements extending over different embodiments may appropriately be combined.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display configured to display video;
a touch panel on the display configured to detect a touch; and
a voice recognition module configured to perform voice recognition processing based on a position of the touch detected by the touch panel.

2. The apparatus of claim 1, wherein the voice recognition module is configured to perform the voice recognition processing for a word or a phrase displayed near the position of the detected touch.

3. The apparatus of claim 2, wherein the voice recognition module is configured to perform the voice recognition processing by using the word or phrase displayed near the position of the detected touch as candidates of the voice recognition processing.

4. The apparatus of claim 1, further comprising:
an editing module configured to edit a text displayed on the touch panel, wherein
the editing module comprises a copy-and-paste function or a cut-and-paste function, and
when a copy or cut start position, a copy or cut end position, or a paste position in the text displayed on the touch panel is specified by a touch operation, the voice recognition module is configured to perform the voice recognition processing for a word or phrase at the copy or cut start position, the copy or cut end position, or the paste position based on words or phrases displayed near the position of the detected touch.

5. The apparatus of claim 4, wherein if a touch state of the text continues for a predetermined time or longer, the editing module is configured to display a menu showing editing items such as copy, cut, and paste on the touch panel.

6. The apparatus of claim 1, wherein the voice recognition module comprises a voice input module configured to input an audio signal and a discrimination module configured to discriminate a word or a phrase similar to the audio signal input by the voice input module from words or phrases near the position of the touch.

7. The apparatus of claim 1, further comprising:
a controller configured to discriminately display a portion of the text displayed on the touch panel, the portion near the position of the touch.

8. The apparatus of claim 1, further comprising:
a controller configured to display phrases near the position of the touch such that a separator of the phrases can be discriminated.

9. The apparatus of claim 6, wherein the discrimination module comprises an analysis module configured to determine characteristic quantities of the audio signal input by the voice input module, a storage configured to store acoustic models, and a module configured to perform the voice recognition processing based on, among the acoustic models stored in the storage, the acoustic models related to words or phrases in a touch region and the characteristic quantities of the audio signal.

10. The apparatus of claim 1, wherein
the touch panel is on a front side of a main body of the information processing apparatus with overlying on an almost entire surface, and
the touch panel comprises a liquid crystal display, and a touch sensor overlying on a display screen of the liquid crystal display configured to detect the position of the touch of the display screen of the liquid crystal display.

11. An information processing method comprising:
performing voice recognition processing based on a touch position on a touch panel.

12. A non-transitory computer-readable storage medium storing computer-executable instructions that, when executed, cause a computer to:
perform voice recognition processing based on a touch position on a touch panel.
